(19) United States
(12) Patent Application Publication
(10) Pub. No.: US 2017/0297941 A1
(43) Pub. Date: Oct. 19, 2017

(54) Indirect heat transfer supercritical water oxidation system and control method thereof

(71) Applicants: XI'AN JIAOTONG UNIVERSITY, Xi'an (CN); XI'AN ENERGY AND ENVIRONMENT TECHNOLOGIES CO., LTD., Xi'an (CN)

(72) Inventors: Shuzhong Wang, Xi'an (CN); Yanhui Li, Xi'an (CN); Jianqiao Yang, Xi'an (CN); Xingying Tang, Xi'an (CN); Jie Zhang, Xi'an (CN); Yuzhen Wang, Xi'an (CN); Tuo Zhang, Xi'an (CN)

(21) Appl. No.: 15/642,335

(22) Filed: Jul. 6, 2017

(51) Int. Cl. C02F 11/08; C02F 1/72

(52) U.S. Cl. CPC C02F 11/086; C02F 1/727; C02F 2209/40; C02F 2209/03

(57) ABSTRACT

An indirect heat transfer supercritical water oxidation system includes a supercritical water oxidation reactant system and an intermediate medium circuit. A control method thereof includes controlling two-process pressure and temperature increase, controlling pressure and temperature decrease and controlling normal operation. The present invention focuses on automatic control strategy of engineering practice of the indirect heat transfer supercritical water oxidation system. The system heating process adopts the idea of circulating heating, which effectively reduces the investment of the heating equipment avoids the mismatch between the working pressure of the two processes, and ensures effectiveness of the heat transfer between supercritical pressure fluid in the inner tube and the outer tube of the preheater/heat exchanger during subsequent heating process. The effective control of a reaction temperature and overpressure protection of critical equipment ensure a process effect and system safety.

### BACKGROUND OF THE PRESENT INVENTION

### Field of Invention

The present invention relates to a technical field supercritical water organic waste treatment, and more particularly to an indirect heat transfer supercritical water oxidation system and a control method thereof.

### Description of Related Arts

Supercritical water (SCW) refers to water with a temperature and pressure higher than its critical point (Tc=374.15° C., Pc=22.12 MPa). Supercritical water oxidation technology takes advantage of low viscosity, low dielectric constant, high diffusivity and other special properties of supercritical water, so that rapid and thorough homogeneous reaction happens between the organic matter completely dissolved in the supercritical water and oxidants. Carbon in the organic matter is converted into carbon dioxide, chlorine, sulfur, phosphorus and other elements and into the corresponding inorganic salts. A vast majority of nitrogen is converted into nitrogen gas. Therefore, organic waste is efficiently and harmlessly treated.

In the conventional supercritical water oxidation process, the investment of material to be treated and direct heat transfer equipment is high, corrosion/blockage risk is high, which is well overcame by the indirect heat transfer supercritical water oxidation process. The process mainly comprises intermediate medium circuit and supercritical water oxidation reactant system. By setting a regenerator, a preheater, and intermediate medium circulation, effluent heat of the supercritical water reaction is indirectly transferred to the subsequent material to be treated. At this point, corrosive fluid passes through inner tube sides of the preheater and the regenerator (preheater inner tube for the material to be treated, regenerator inner tube for the supercritical water oxidation effluent), and outer tube sides are clean desalted water. Therefore, only inner tubes of the preheater and the regenerator need to use high-end corrosion-resistant alloy, and the outer tubes can be cheap carbon steel or low alloy steel, thus greatly reducing investment cost of preheating-cooling equipment of the supercritical water oxidation process. In addition, the outer tube sides contain clean desalted water, avoiding blockage risk of the outer tube sides with dirty fluid (material to be treated or reaction effluent).

### SUMMARY OF THE PRESENT INVENTION

For overcoming problems that process parameters of the indirect heat transfer supercritical water oxidation system mentioned in the background are high, and temperature and pressure matching between two processes are strictly demanded, an object of the present invention is to provide an indirect heat transfer supercritical water oxidation system and a control method thereof.

Accordingly, in order to accomplish the above object, the present invention provides:

an indirect heat transfer supercritical water oxidation system, comprising: a supercritical water oxidation reactant system, an intermediate medium circuit, and a salt water replenishment system; wherein the supercritical water oxidation reactant system comprises a material buffer tank, wherein the material buffer tank is connected to an inner tube of a preheater through a material pump; an output of the inner tube of the preheater is connected to an inner tube of a reactor through a desuperheater; an output of the inner tube of the reactor communicates with an inner tube of a regenerator; an output of the inner tube of the regenerator communicates with an input of a three-phase separator;

wherein the intermediate medium circuit comprises a buffer tank and a pipeline booster pump, wherein an output of the buffer tank is connected to the pipeline booster pump; an output of the pipeline booster pump communicates with an outer tube of the regenerator; an output of the outer tube of the regenerator is connected to a heater; an output of the heater communicates with an outer tube of the preheater; an output of the outer tube of the preheater is connected to an input of the buffer tank.

The present invention also provided a control method of the indirect heat transfer supercritical water oxidation system, comprising steps of:

1) before starting the indirect heat transfer supercritical water oxidation system, keeping all control valves closed and all back pressure valves opened;

2) starting the indirect heat transfer supercritical water oxidation system, which specifically comprises steps of:

2-1) injecting desalted water into a supercritical water oxidation reactant system through a material pump, gradually adjusting a pressure decreasing device until a pressure at a reactor is increased to a target valve A1, so as to complete main process boost;

2-2) setting a reflow back pressure valve to a target valve A2, injecting desalted water into a buffer tank through a high pressure variable frequency pump, then starting a pipeline booster pump for medium circulation of an intermediate medium circuit; gradually adjusting an opening degree of a back pressure valve until a pressure inside the buffer tank is increased to the target valve A2, so as to complete intermediate medium circuit boost;

2-3) heating intermediate medium with a heater, adjusting a power of the heater for a constant heating rate at an input of the reactor; after the input of the reactor reaches a target temperature B1, changing fluid at an input of the material pump to an untreated material in a material tank; meanwhile, opening an oxygen control valve for supplying oxygen to the reactor, so as to complete system starting;

3) normally operating, which specifically comprises steps of:

a) increasing the opening degree of the back pressure valve for decompression if the pressure inside the buffer tank is increased; opening a control valve for supplying water to the buffer tank if the pressure inside the buffer tank is decreased;

b) maintaining the reactor by adjusting flow rates of the pressure decreasing device and the material pump, so as to keep a pressure of 25±1 MPa;

c) increasing the power of the heater if a temperature at an output of the reactor is lower than B2; decreasing the power of the heater if the temperature at the output of the reactor is higher than B3; stopping the heater if a max temperature at a top surface of the reactor is up to B4; starting a desuperheater control valve if the max temperature at the top surface of the reactor is increased to B5; and

4) stopping the indirect heat transfer supercritical water oxidation system, which specifically comprises steps of:

4-1) closing an oxygen pipeline control valve for stopping oxygen supply; changing the fluid at the input of the material pump to desalted water; adjusting the power of the heater for a constant cooling rate at the output of the reactor; controlling the pressure decreasing device and the back pressure valve for respectively keeping pressures at the output of the reactor and inside the buffer tank at a target value A;

4-2) stopping the material pump, the pipeline booster pump and the high pressure variable frequency pump when the temperature at the output of the reactor is decreased to a target temperature B6; controlling the pressure decreasing device and the back pressure valve for gradually lowering pressures at two circuits thereof to an atmospheric pressure;

wherein a target temperature relation is: B6<B1<B2<B3<B4<B5.

Compared with convention technologies, the present invention has beneficial effects as follows.

The present invention uses an intermediate heat conduction system, so that effluent heat of the supercritical water reaction is indirectly transferred to a subsequent material to be treated. Different from heat transfer device whose effluent directly preheats the material to be treated, only the inner tubes of the preheater and the regenerator of the present invention should be made of high-end corrosion resistant alloy, and the outer tube is made of carbon steel or low alloy steel, thus greatly reducing investment cost of preheating-cooling equipment of the supercritical water oxidation process.

More detailed, corrosive fluid passes through inner tube sides of the preheater and the regenerator of the present invention (preheater inner tube for the material to be treated, regenerator inner tube for the supercritical water oxidation effluent), and outer tube sides are clean desalted water. Therefore, only inner tubes of the preheater and the regenerator need to use high-end corrosion-resistant alloy, and the outer tubes can be cheap carbon steel or low alloy steel, thus greatly reducing investment cost of preheating-cooling equipment of the supercritical water oxidation process. In addition, the outer tube sides contain clean desalted water, avoiding blockage risk of the outer tube sides with dirty fluid (material to be treated or reaction effluent).

The control method of the indirect heat transfer supercritical water oxidation system of the present invention is provided.

When the system is started, the temperature is boosted after pressure boost. First, the pressurization of the two processes is carried out for matching working pressures between the two, so to ensure effectiveness of the heat transfer between supercritical pressure fluid in the inner tube and the outer tube of the preheater/heat exchanger during subsequent heating process. By adjusting the intermediate medium circuit back pressure valve and a reaction main process pressure decreasing device, the work pressure of the two processes is maintained to ensure success of the heating process.

The system starts cycle heating: the intermediary media cycles several times in the heater for absorbing heat, so as to increase its own temperature and transfer part of the heat to the main reaction process at the same time, thus finally realizing temperature increase of the entire system. At this point, the heater does not need to heat the intermediate medium to a target temperature value at one time, so a design power of the heater is low, leading to low investment cost.

When the system is stopped, the temperature is decreased before pressure decrease. By adjusting the intermediate medium circuit back pressure valve and the reaction main process pressure decreasing device, the work pressure of the two processes is maintained to ensure effectiveness of the heat transfer between supercritical pressure fluid in the inner tube and the outer tube of the preheater/heat exchanger during subsequent heating process. When the system is cooled to about a room temperature, the intermediate medium circuit back pressure valve and the reaction main process pressure decreasing device are adjusted for gradually lowering pressures of two processes.

When the system is running normally, the power of the heater is adjusted to ensure that a reactor operating temperature is within the normal range; the reactor is equipped with two-stage over-temperature protection measures: heater stop and water cooling. Referring to the processes, a pressure interlock control method is used to maintain normal pressures of the two processes, so as to ensure that the intermediate medium thermal effect is good.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of according to the present invention.

FIG. 2 is a schematic view of according to a preferred embodiment of the present invention.

Element reference: material buffer tank (1), material pump (2), preheater (3), desuperheater (4), reactor (5), regenerator (6), pressure decreasing device (7), three-phase separator (8), desalted water tank (9), pipeline booster pump (10), heater (11), buffer tank (12), back pressure valve (13), high pressure variable frequency pump (14), reflow back pressure valve (15), gas-liquid separator (16), on-line micro filter (17), oxygen buffer tank (18), pressure regulator (19), drug storage (20), drug feeding pump (21), pressure regulator (22), liquid oxygen vaporizer (23), liquid oxygen tank (24), liquid oxygen pump (25), material buffer tank output control valve (V1), desalted water pipeline control valve (V2), water replenishment control valve (V3), desuperheater control valve (V4), oxygen control valve (V5), first switch valve (101), second switch valve (102), third switch valve (103).

### DETAILED DESCRIPTION OF THE PREFERRED EMBODIMENT

Referring to the drawings, the present invention is further illustrated.

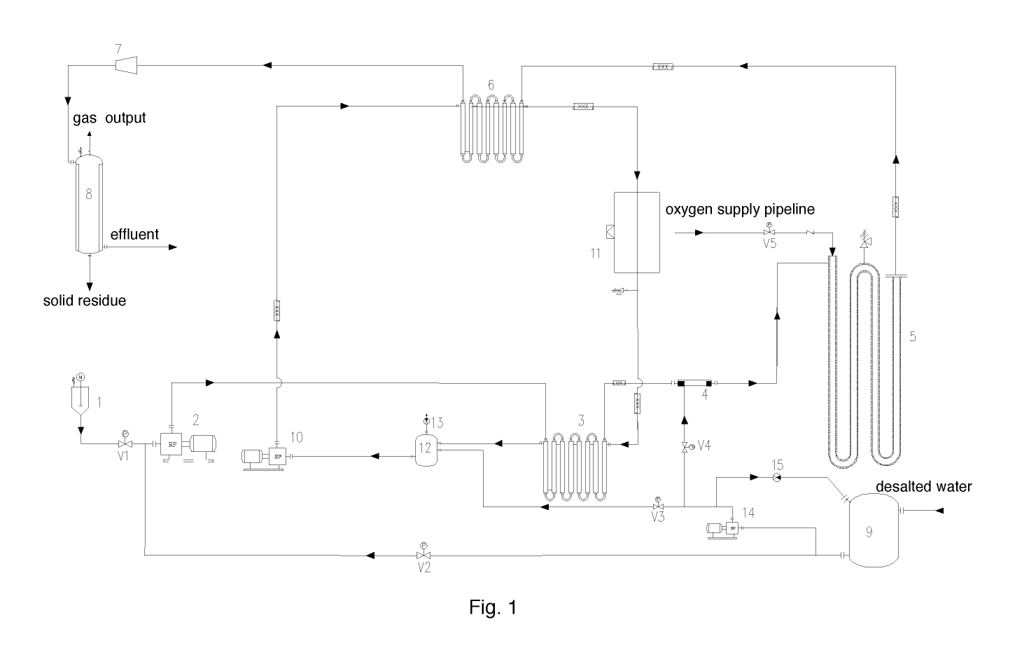

Referring to FIG. 1, an indirect heat transfer supercritical water oxidation system of the present invention comprises: a supercritical water oxidation reactant system, an intermediate medium process, and other assisting pipelines; wherein the supercritical water oxidation reactant system comprises a material buffer tank 1 connected to a material pump 2, and a material buffer tank output control valve V1 is provided therebetween; the material pump 2 is connected is connected to an inner tube of a preheater 3; an output of the inner tube of the preheater 3 is connected a first input of the desuperheater 4; an output of the desuperheater 4 is connected to a first input of a reactor 5; an output of the reactor 5 is connected an inner tube of a regenerator 6; an output of the inner tube of the regenerator 6 is connected to a pressure decreasing device 7; an output of the pressure decreasing device 7 is connected to a three-phase separator 8. The intermediate medium circuit comprises a buffer tank 12 whose output is connected to a pipeline booster pump 10; an output of the pipeline booster pump 10 is connected an outer tube of the regenerator 6; an output of the outer tube of the regenerator 6 is connected to a heater 11; an output of the heater 11 is connected to an outer tube of the preheater 3; an output of the outer tube of the preheater 3 is connected to a first input of a buffer tank 12, and a back pressure valve 13 is provided on a top portion of the buffer tank 12. The other assisting pipelines comprises a desalted water tank 9 whose first tank line is connected to a tube between a material pump 2 and material buffer tank output control valve V1 through a desalted water pipeline control valve V2; a second tank line of the desalted water tank 9 is connected to a high pressure variable frequency pump 14; an output of the high pressure variable frequency pump 14 is divided into a first pump line, a second pump line and a third pump line, wherein the first pump line returns to the desalted water tank 9 through a reflow back pressure valve 15, the second pump line is connected to a second input of the desuperheater 4 through a desuperheater control valve V4; and the third pump line is connected to a second input of the buffer tank 12 through a water replenishment control valve V3; an oxygen pipeline is connected to a second input of the reactor 5 through an oxygen control valve V5.

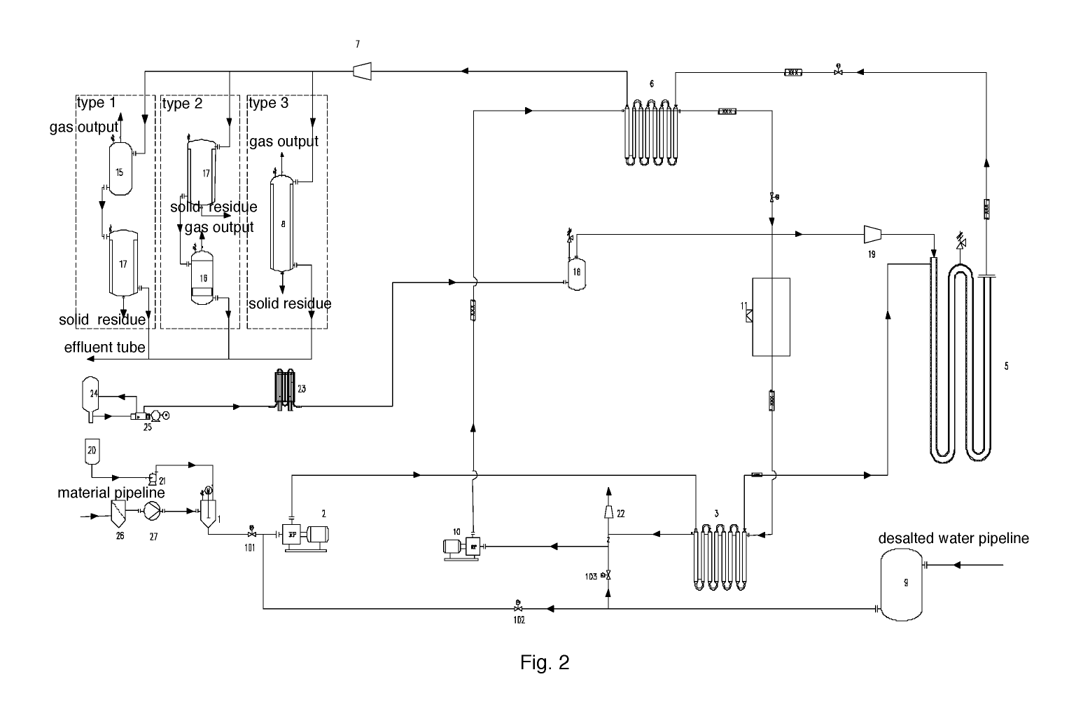

Referring to FIG. 2, the oxygen supply system comprises a liquid oxygen tank 24, a liquid oxygen pump 25, a liquid oxygen vaporizer 23, an oxygen buffer tank 18 and an oxygen pressure regulator 19, wherein the liquid oxygen tank 24 is connected to the liquid oxygen pump 25, the liquid oxygen pump 25 is connected to the liquid oxygen vaporizer 23, the liquid oxygen vaporizer 23 is connected to the oxygen buffer tank 18, the oxygen buffer tank 18 is connected to the oxygen pressure regulator 19, and the oxygen pressure regulator 19 is connected to the input of the reactor 5.

The supercritical water oxidation reactant system comprises the material pump 2, the preheater 3, the reactor 5, the regenerator 6, the pressure decreasing device 7 and the three-phase separator sub-system, wherein an input of the material pump 2 is connected an output of the material buffer tank 1, an output of the material pump 2 is connected to an input of the inner tube of the preheater 3; the output of the inner tube of the preheater 3 is connected to the input of the reactor 5, the output of the reactor 5 is connected the inner tube of the regenerator 6, the output of the inner tube of the regenerator 6 is connected to the pressure decreasing device 7, the output of the pressure decreasing device 7 is connected to the three-phase separator sub-system, and output of the three-phase separator sub-system is connected to an effluent tube of the system.

The three-phase separator sub-system comprises a gas-liquid separator 16, an on-line micro filter 17 or the three-phase separator 8, wherein the gas-liquid separator 16 is connected the output of the pressure decreasing device 7, an output of the gas-liquid separator 16 is connected to the on-line micro filter 17, an output of the on-line micro filter 17 is connected to the effluent tube of the system; or an input of the on-line micro filter 17 is connected to an input of the gas-liquid separator 16, the output of the gas-liquid separator 16 is connected to the effluent tube of the system; or the input of the three-phase separator 8 is connected to the output of the pressure decreasing device 7, the output of the three-phase separator 8 is connected to the effluent tube of the system.

Principles and processes of the present invention are as follows.

First, the salted water is injected into the desalted tank 9 from outside. A first desalted water line from the desalted tank 9 reaches the pipeline booster pump 10 through a third switch valve 103. The pipeline booster pump 10 is located at a lowest point of the intermediate medium circuit. Through the pipeline booster pump 10, intermediate medium flows through the outer tube of the regenerator 6, the heater 11, the outer tube of the preheater 3 and the pressure regulator 22 in sequence for water supply of the intermediate medium circuit. After water supply, an open degree of the pressure regulator 22 at a highest point of the intermediate medium circuit is adjusted to boost pressure of the intermediate medium circuit, and then the third switch valve 103 is closed. Meanwhile, a second desalted water line from the desalted tank 9 reaches the material pump 2 via a second switch valve 102. Through the material pump 2, the desalted water flows through the inner tube of the preheater 3, the reactor 5, the inner tube of the regenerator 6, the pressure decreasing device 7 and the three-phase separator sub-system in sequence for finally entering the effluent tube of the system. The pressure decreasing device 7 is gradually adjusted to gradually increase the pressure at the reactor 5 to a supercritical pressure. The intermediate medium is heated by the heater 11, and the pipeline booster pump 10 provides a circulation force for the intermediate medium. After a certain period of cycle heating, a reactor inlet temperature can be raised to a target value, which completes system temperature increase.

After the system pressure and temperature is increased, a material at the input of the material pump 2 is switched from the desalted water from the desalted tank 9 to an untreated material from the material buffer tank 1. After treatment with an insoluble filter 26 and a grinding pump 27, a particle size of insoluble solid particles in the material buffer tank 1 can be controlled under 50 μm. In addition, a drug from a drug storage 20 is introduced into the material buffer tank 1 through a drug feeding pump 21, wherein with a mixer in the the material buffer tank 1, the material is homogeneously processed, so as to meet system feeding requirements of the supercritical water oxidation device. The processed untreated material enters the preheater 3 through the material pump 2 and is preheated to a target preheating temperature by high temperature intermediate medium in the outer tube of the preheater 3, and then enters the reactor 5. Liquid oxygen from the liquid oxygen tank 24 flows through the liquid oxygen pump 25 and the liquid oxygen vaporizer 23 in sequence, and then enters the oxygen buffer tank 18 in a form of oxygen gas which enters the reactor 5 after being pressurized by the pressure regulator 19. In the reactor 5, the untreated material reaching the target preheating temperature reacts with oxygen, releasing a certain amount of heat. Effluent of supercritical water oxidation enters the inner tube of the regenerator 6 to transfer heat to the intermediate medium in the outer tube of the regenerator 6. With the pipeline booster pump 10, the intermediate medium circulates in the intermediate medium circuit and absorbs heat from effluent of the inner tube of the regenerator 6, which needs to be supplemented with heat when passing through the heater 11. Then the intermediate medium flows into the outer tube of the preheater 3 and transfers heat to the material in the inner tube of the preheater 3, so as to preheat the untreated material. Cooled effluent from the inner tube of the regenerator 6 is reduced to an appropriate pressure by the pressure decreasing device 7 and then enters the three-phase separator sub-system for three-phase separation.

Three-phase separator sub-system implementation process can be divided into three types as shown in FIG. 2. One, a gas phase is firstly separated and then liquid-solid separation is achieved: the cooled effluent from the pressure decreasing device 7 firstly enters the gas-liquid separator 16, and gas phase products as well as residual oxygen gas are discharged from a top portion thereof, a liquid-solid mixture enters the on-line micro filter 17 from a bottom outlet for liquid-solid separation in the on-line micro filter 17, and solid phase residue is continuously or intermittently discharged from a bottom discharge port, and a liquid phase flows out of a liquid discharge port and then enters the effluent tube of the system. Two, a solid phase is firstly separated and then gas-liquid separation is achieved: the cooled effluent from the pressure decreasing device 7 firstly enters the on-line micro filter 17, and solid phase residue is continuously or intermittently discharged from the bottom discharge port; a gas-liquid mixture enters the gas-liquid separator 16, and gas phase products as well as residual oxygen gas are discharged from the top portion thereof; a liquid phase flows out of the liquid discharge port and then enters the effluent tube of the system. Three, three-phase separation is achieved at the same time: the cooled effluent from the pressure decreasing device 7 firstly enters the three-phase separator 8, and phase products as well as residual oxygen gas are discharged from a top portion thereof; solid phase residue is continuously or intermittently discharged from a bottom discharge port, and a liquid phase flows out of a liquid discharge port and then enters the effluent tube of the system.

An adjusting method during normally operating comprises steps of: a) increasing the opening degree of the back pressure valve 13 for decompression if the pressure inside the buffer tank 12 is increased; opening a water replenishment control valve V3 for supplying water to the buffer tank 12 if the pressure inside the buffer tank 12 is decreased; b) maintaining the reactor 5 by adjusting flow rates of the pressure decreasing device 7 and the material pump 2, so as to keep a pressure within a normal range; c) increasing the power of the heater 11 if a temperature at an output of the reactor 5 is lower than B2; decreasing the power of the heater 11 if the temperature at the output of the reactor 5 is higher than B3; stopping the heater 11 if a max temperature at a top surface of the reactor 5 is up to B4; starting a desuperheater control valve V4 if the max temperature at the top surface of the reactor 5 is increased to B5 for system safety.

When the system receives a stop order: opening the desalted water pipeline control valve V2 and closing a material buffer tank output control valve V1 for changing the fluid at the input of the material pump 2 to desalted water; closing an oxygen control valve V5 for stopping oxygen supply; adjusting the power of the heater 11 for a constant cooling rate at the output of the reactor 5; controlling the pressure decreasing device 7 and the back pressure valve 13 for respectively keeping pressures at the output of the reactor 5 and inside the buffer tank 12 at target values A1 and A2; stopping the material pump 5, the pipeline booster pump 13 and the high pressure variable frequency pump 14 when the temperature at the output of the reactor 5 is decreased to a target temperature B6; controlling the pressure decreasing device 7 and the back pressure valve 13 for gradually lowering pressures at two circuits thereof to an atmospheric pressure.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An indirect heat transfer supercritical water oxidation system, comprising: a supercritical water oxidation reactant system, an intermediate medium circuit, and a salt water replenishment system; wherein the supercritical water oxidation reactant system comprises a material buffer tank (1), wherein the material buffer tank (1) is connected to an inner tube of a preheater (3) through a material pump (2); an output of the inner tube of the preheater (3) is connected to an inner tube of a reactor (5) through a desuperheater (4); an output of the inner tube of the reactor (5) communicates with an inner tube of a regenerator (6); an output of the inner tube of the regenerator (6) communicates with an input of a three-phase separator (8);
wherein the intermediate medium circuit comprises a buffer tank (12) and a pipeline booster pump (10), wherein an output of the buffer tank (12) is connected to the pipeline booster pump (10); an output of the pipeline booster pump (10) communicates with an outer tube of the regenerator (6); an output of the outer tube of the regenerator (6) is connected to a heater (11); an output of the heater (11) communicates with an outer tube of the preheater (3); an output of the outer tube of the preheater (3) is connected to an input of the buffer tank (12).

2. The indirect heat transfer supercritical water oxidation system, as recited in claim 1, wherein an input of the inner tube of the reactor (5) is connected to an oxygen pipeline through an oxygen control valve (V5).

3. The indirect heat transfer supercritical water oxidation system, as recited in claim 1, wherein a material buffer tank output control valve (V1) is provided on a tube at an output of the material buffer tank (1).

4. The indirect heat transfer supercritical water oxidation system, as recited in claim 1, wherein a back pressure valve (13) for adjusting a pressure of the intermediate medium circuit is provided on the buffer tank (12).

5. The indirect heat transfer supercritical water oxidation system, as recited in claim 1, wherein a pressure regulator (22) is provided on a tube between the pipeline booster pump (10) and the preheater (3).

6. The indirect heat transfer supercritical water oxidation system, as recited in claim 1, wherein the salt water replenishment system comprises a desalted water tank (9), wherein an output of the desalted water tank (9) is divided into a first tank line and a second tank line; the first tank line is connected to a tube before a material input, and the second tank line is connected to an input of a high pressure variable frequency pump (14); an output of the high pressure variable frequency pump (14) is divided into a first pump line, a second pump line and a third pump line, the first pump line communicates with the input of the buffer tank (12), the second pump line communicates with an input of the desuperheater (4), and the third pump line communicates with an input of the desalted water tank (9).

7. The indirect heat transfer supercritical water oxidation system, as recited in claim 6, wherein a desalted water pipeline control valve (V2) is provided on a tube between the output of the desalted water tank (9) and the material input; the high pressure variable frequency pump (14) is connected to the buffer tank (12) through a water replenishment control valve (V3), connected to the desuperheater (4) through a desuperheater control valve (V4), and connected to the desalted water tank (9) through a reflow back pressure valve (15).

8. The indirect heat transfer supercritical water oxidation system, as recited in claim 1, further comprising an oxygen supply system, wherein the oxygen supply system comprises a liquid oxygen tank (24) whose output communicates with a liquid oxygen pump (25), a liquid oxygen vaporizer (23), an oxygen buffer tank (18) and an oxygen pressure regulator (19) in sequence, wherein an output of the pressure regulator (19) communicates with an input of the reactor (5).

9. The indirect heat transfer supercritical water oxidation system, as recited in claim 8, further comprising a material pretreatment system, wherein the material pretreatment system comprises the material buffer tank (1) whose output communicates with an input of the supercritical water oxidation reactant system; wherein an input of the material buffer tank (1) is respectively connected to an insoluble filter (26) and a drug storage (20); an input the insoluble filter (26) is connected to a material input tube; a grinding pump (27) is provided at a tube between an output of the insoluble filter (26) and the material buffer tank (1); a drug feeding pump (21) is provided at a tube between the drug storage (20) and the material buffer tank (1).

10. The indirect heat transfer supercritical water oxidation system, as recited in claim 1, wherein an output of a pressure decreasing device (7) is connected to a gas-liquid separator (16) and an on-line micro filter (17) in sequence; an output of the on-line micro filter (17) communicates with an effluent tube of the indirect heat transfer supercritical water oxidation system.

11. The indirect heat transfer supercritical water oxidation system, as recited in claim 6, wherein an output of a pressure decreasing device (7) is connected to a gas-liquid separator (16) and an on-line micro filter (17) in sequence; an output of the on-line micro filter (17) communicates with an effluent tube of the indirect heat transfer supercritical water oxidation system.

12. The indirect heat transfer supercritical water oxidation system, as recited in claim 8, wherein an output of a pressure decreasing device (7) is connected to a gas-liquid separator (16) and an on-line micro filter (17) in sequence; an output of the on-line micro filter (17) communicates with an effluent tube of the indirect heat transfer supercritical water oxidation system.

13. The indirect heat transfer supercritical water oxidation system, as recited in claim 1, wherein an output of a pressure decreasing device (7) is connected to an on-line micro filter (17) and a gas-liquid separator (16) in sequence; an output of the gas-liquid separator (16) communicates with an effluent tube of the indirect heat transfer supercritical water oxidation system.

14. The indirect heat transfer supercritical water oxidation system, as recited in claim 6, wherein an output of a pressure decreasing device (7) is connected to an on-line micro filter (17) and a gas-liquid separator (16) in sequence; an output of the gas-liquid separator (16) communicates with an effluent tube of the indirect heat transfer supercritical water oxidation system.

15. The indirect heat transfer supercritical water oxidation system, as recited in claim 8, wherein an output of a pressure decreasing device (7) is connected to an on-line micro filter (17) and a gas-liquid separator (16) in sequence; an output of the gas-liquid separator (16) communicates with an effluent tube of the indirect heat transfer supercritical water oxidation system.

16. The indirect heat transfer supercritical water oxidation system, as recited in claim 1, wherein an output of a pressure decreasing device (7) is connected to the three-phase separator (8), and a liquid output of the three-phase separator (8) communicates with an effluent tube of the indirect heat transfer supercritical water oxidation system.

17. The indirect heat transfer supercritical water oxidation system, as recited in claim 6, wherein an output of a pressure decreasing device (7) is connected to the three-phase separator (8), and a liquid output of the three-phase separator (8) communicates with an effluent tube of the indirect heat transfer supercritical water oxidation system.

18. The indirect heat transfer supercritical water oxidation system, as recited in claim 8, wherein an output of a pressure decreasing device (7) is connected to the three-phase separator (8), and a liquid output of the three-phase separator (8) communicates with an effluent tube of the indirect heat transfer supercritical water oxidation system.

19. A control method of an indirect heat transfer supercritical water oxidation system as recited in claim 9, comprising steps of:
1) before starting the indirect heat transfer supercritical water oxidation system, keeping all control valves closed and all back pressure valves opened;
2) starting the indirect heat transfer supercritical water oxidation system, which specifically comprises steps of:
2-1) injecting desalted water into a supercritical water oxidation reactant system through a material pump (2), gradually adjusting a pressure decreasing device (7) until a pressure at a reactor (5) is increased to a target valve A1, so as to complete main process boost;
2-2) setting a reflow back pressure valve (15) to a target valve A2, injecting desalted water into a buffer tank (12) through a high pressure variable frequency pump (14), then starting a pipeline booster pump (10) for medium circulation of an intermediate medium circuit; gradually adjusting an opening degree of a back pressure valve (13) until a pressure inside the buffer tank (12) is increased to the target valve A2, so as to complete intermediate medium circuit boost;
2-3) heating intermediate medium with a heater (11), adjusting a power of the heater (11) for a constant heating rate at an input of the reactor (5); after the input of the reactor (5) reaches a target temperature B1, changing fluid at an input of the material pump (2) to an untreated material in a material tank (1); meanwhile, opening an oxygen control valve (17) for supplying oxygen to the reactor (5), so as to complete system starting;
3) normally operating, which specifically comprises steps of:
a) increasing the opening degree of the back pressure valve (13) for decompression if the pressure inside the buffer tank (12) is increased; opening a water replenishment control valve (V3) for supplying water to the buffer tank (12) if the pressure inside the buffer tank (12) is decreased;
b) maintaining the reactor (5) by adjusting flow rates of the pressure decreasing device (7) and the material pump (2), so as to keep a pressure of 25±1 MPa;
c) increasing the power of the heater (11) if a temperature at an output of the reactor (5) is lower than B2; decreasing the power of the heater (11) if the temperature at the output of the reactor (5) is higher than B3; stopping the heater (11) if a max temperature at a top surface of the reactor (5) is up to B4; starting a desuperheater control valve (V4) if the max temperature at the top surface of the reactor (5) is increased to B5; and
4) stopping the indirect heat transfer supercritical water oxidation system, which specifically comprises steps of:
4-1) closing an oxygen control valve (V5) for stopping oxygen supply;
changing the fluid at the input of the material pump (2) to desalted water; adjusting the power of the heater (11) for a constant cooling rate at the output of the reactor (5);
controlling the pressure decreasing device (7) and the back pressure valve (13) for respectively keeping pressures at the output of the reactor (5) and inside the buffer tank (12) at a target value A;
4-2) stopping the material pump (2), the pipeline booster pump (10) and the high pressure variable frequency pump (14) when the temperature at the output of the reactor (5) is decreased to a target temperature B6; controlling the pressure decreasing device (7) and the back pressure valve (13) for gradually lowering pressures at two circuits thereof to an atmospheric pressure;
wherein a target temperature relation is: B6<B1<B2<B3<B4<B5.
